(19) United States
(12) Patent Application Publication
(10) Pub. No.: US 2001/0019003 A1
(43) Pub. Date: Sep. 6, 2001

(54) Free wheel retaining ring

(75) Inventors: Siegfried Jackwerth, Friedrichsdorf (DE); Karlheinz Timtner, Bad Homburg (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Ringspann GmbH

(21) Appl. No.: 09/795,031

(22) Filed: Feb. 27, 2001

(30) Foreign Application Priority Data
Feb. 29, 2000 (DE) 100 09 450.3

(51) Int. Cl. F16D 41/07

(52) U.S. Cl. 192/45.1; 192/41 A

(57) ABSTRACT

A free wheel retaining ring has a plurality of clamping elements pivotably mounted and biased by at least one spring toward an engaging position, wherein the clamping elements are supported radially outwardly on the edge of the retaining ring and execute a swivelling motion acting toward a disengaging position, under the action of centrifugal force against the force of the spring. The free wheel retaining ring is constructed in one piece and has in its cylindrical region a plurality of windows following one after the other in the circumferential direction, in which the clamping elements are guided in the circumferential direction while simultaneously being supported radially outwardly.

### BACKGROUND OF THE INVENTION

The invention relates to a free wheel retaining ring, in which a plurality of clamping elements are pivotably mounted and are biased toward an engaging position by at least one spring, wherein the clamping elements are supported radially outwardly on the retaining ring and execute a swiveling motion acting toward a disengaging position, under the action of centrifugal force against the force of the spring.

Such a free wheel retaining ring is known from German patent publication DE 20 04 457. It has the advantage that, during idling operation, the clamping elements do not lift off from the inner ring, as usual, but instead from the outer ring.

It is basically known with free wheeling that the retaining ring circulates together with the free wheel outer ring during idling, while the free wheel inner ring stands still. Here, the clamping elements are pressed outwardly by the centrifugal force acting upon them, are swivelled toward the disengaging position, and are thereby lifted from the free wheel inner ring.

In contrast, the device of DE 20 04 427 does not allow the clamping elements during idling to lift off from the inner ring, but rather from the outer ring. This alternative is needed when, during idling operation, the free wheel inner ring circulates while the outer ring stands still. For this purpose, the center of gravity of the clamping elements must be shifted in relation to the clamping elements pivoting axis, such that the swivelling motion toward a disengaging position leads to a lift off of the clamping elements from the free wheel outer ring. Since the supporting of the clamping elements in relation to the influence of centrifugal force in this case can no longer take place by means of the outer ring, they are supported on a concentric support ring or on the retaining ring, which stands in friction-locking connection with the free wheel inner ring.

In this manner, any wear of the free wheel during idling is ruled out, as soon as the number of rotations required for centrifugal force lifting of the clamping elements is exceeded. This has therefore special significance, because even minor material abrasions on the clamping elements can lead to disturbances in function as a consequence of uneven engagement and ultimately to a failure of the free wheel with dangerous consequences for the operating personnel.

In DE 20 04 457, from which the present application proceeds, the retaining ring consists of two annular collar disks extending essentially radially, between which the clamping elements are arranged. Both collar disks have bevels on their radial outer edge directed toward one another, on which the clamping elements are supported against the influence of centrifugal force by means of pivot bearings arranged on the end faces. The connection of the two collar disks takes place by several axially extending bolts distributed around the periphery. With this known retaining ring a good supporting of the clamping elements against the centrifugal forces is indeed guaranteed. The axis-parallel alignment of the clamping elements is, however, unsatisfactory for numerous applications.

It is therefore also known from German patent publication DE 44 43 723 to arrange separately finished pockets on the collar disks mentioned, which follow one after another in a circumferential direction, such that two pockets are allocated to each clamping element in its axial extension, which engage around the clamping element on opposite faces. The clamping elements are thereby exactly guided even in the circumferential direction, and by means of the radial supporting they are suited for the centrifugal force lift off from the outer ring.

### SUMMARY OF THE INVENTION

Underlying the present invention is the objective of making available a retaining ring which offers an exact guidance or supporting of the clamping elements in the circumferential direction as well as against the centrifugal force, which is nevertheless substantially more economically producible than the two retaining ring types described above.

This objective is accomplished in accordance with the invention, in that the retaining ring is in one piece and has in its cylindrical region a plurality of windows following one after another in the circumferential direction, in which the clamping elements are guided in the circumferential direction while simultaneously being supported radially outwardly.

With this configuration the retaining ring of the invention distinguishes itself by extraordinarily favorable production costs, since the windows can be created by a simple stamping operation. At the same time, its weight and its moment of inertia are considerably diminished, so that it reacts more rapidly during clutching, and the synchronization phase (associated with wear) is shortened up to engagement of the clutch.

Similar retaining rings with windows are indeed already known from German patent publication DE 19 15 567. However, they do not permit the supporting of the clamping elements in a radial direction, so that there, during idling operation, only a lifting off of the clamping elements from the free wheel inner ring is possible.

In the sense of the centrifugal force lift off of the clamping elements from the outer ring sought in accordance with the invention, it is recommended that the retaining ring not (as perhaps with DE 19 15 567) run at the average height of the clamping elements, but rather radially further outward, so that it encompasses with its windows the halves of the clamping elements lying radially outward. Its inner circumferential surface is therefore available as a supporting surface for pivotable mounting of the clamping elements, and at the same time also accommodates the centrifugal forces. Moreover, this positioning of the retaining ring permits a favorable distribution of mass of the clamping elements in relation to their lift off motion from the outer ring.

For the spring loading of the clamping elements, it is possible to fall back upon known solutions. It is particularly expedient, however, if the springs are separably fastened on the retaining ring, in particular separably suspended in its windows. The assembly is thereby substantially facilitated.

Frequently it is desired to supply to customers the retaining ring together with all its clamping elements, but without inner and outer ring. Here, there arises the problem that the clamping elements slip out of the retaining ring and must be reinstalled by the customer. This requires not only experience and skill, but with a faulty installation—even of a single clamping element—can lead to a total breakdown of the free wheel. Here, a particularly expedient refinement of the invention applies, in that the springs, which are necessary in any case, are constructed as formed parts, preferably one-piece sheet formed parts (e.g., punched, stamped or bent metal sheet or injection molded parts), which surround the clamping elements like a pocket or clamp and hold them captively in the retaining ring. At the same time, by this measure, the assembly of the free wheel at the manufacturer itself is also facilitated. The spring can in this case be constructed as a flat bending or flexing spring, particularly as a leaf spring.

For captive mounting of the clamping rings on the retaining ring, it is recommended that the formed part engage the trunnions, usually arranged on the end faces of the clamping element, on the radially inward-lying sides, so that the clamping elements are guided radially outward as well as radially inward. These two lateral legs are expediently constructed on their ends such that they, as well as the other end of the formed part, can be suspended in the retaining ring.

In order to facilitate the assembly of the clamping elements in the retaining ring, the two lateral legs of the formed part are expediently constructed to be elastic in the axial direction, so that the clamping elements, despite the laterally projecting trunnions, can be radially inserted into the formed part, although the formed part itself is already suspended in the retaining ring.

There exists the possibility of manufacturing the formed parts from two axially adjacent parts, which are each suspended separately into the retaining ring. It is also possible, however, to join several successive formed parts with one another, perhaps in the form of a continuously stamped band. In the extreme case, all formed parts are joined into one ring.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is an axial section view through a free wheel in the installed state, sectioned along the line I-I in FIG. 2;

FIG. 2 is a section view along line II-II in FIG. 1;

FIG. 3 is a radial plan view of the free wheel from the outside according to arrow A in FIG. 2;

FIG. 4 is the same view as FIG. 3, but with another sheet formed part;

FIGS. 5a, 5b and 5c are three side views and FIG. 5d is a perspective view of a sheet formed part according to a first embodiment;

FIGS. 6a, 6b, 6c, and 6d are the same views as FIGS. 5a-5d of a sheet formed part according to a second embodiment;

FIGS. 7a, 7b, 7c, and 7d are the same views as FIGS. 5a-5d of a sheet formed part according to a third embodiment;

FIG. 8 is an enlarged side view similar to FIG. 2 with the clamping elements in engaged and disengaged positions; and

FIG. 9 is a section view similar to FIG. 1, but with a retaining ring without bevel.

### DETAILED DESCRIPTION OF THE INVENTION

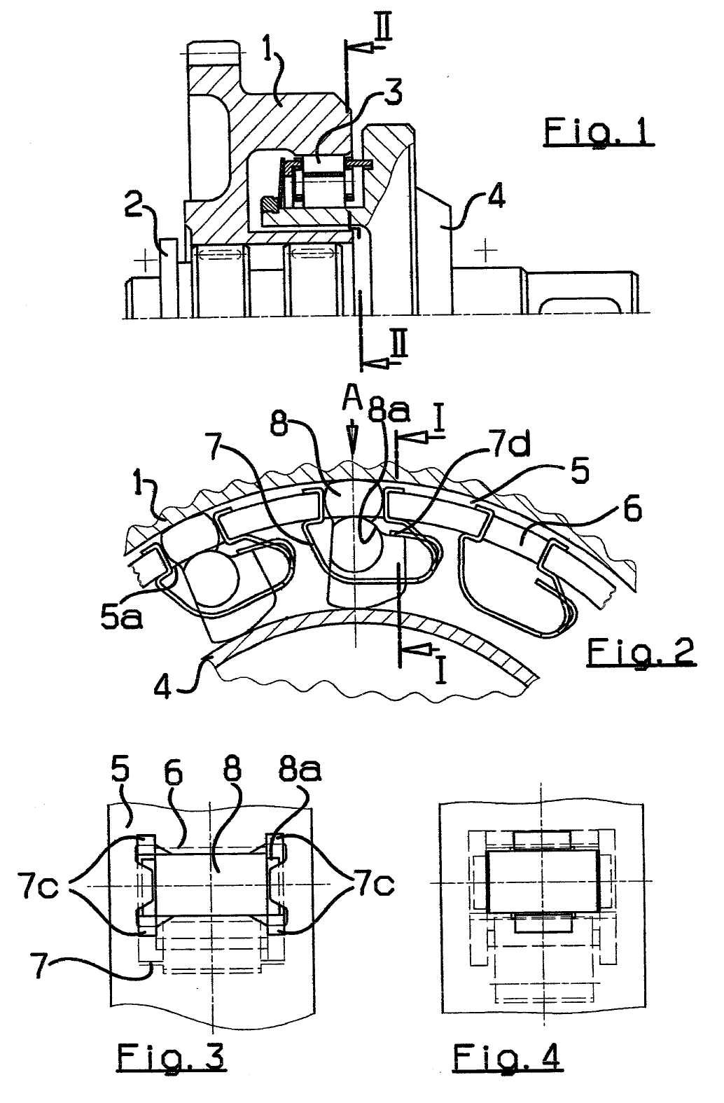

In FIG. 1, one will recognize a gear wheel 1, which is mounted on the one hand on a shaft 2, on the other hand stands on a free wheel 3 in operative connection with a coaxially arranged shaft element 4. The free wheel 3 comprises, as is apparent from FIGS. 2 to 4, a retaining ring 5 having an L-shaped cross section, which extends mainly in an axial direction and has in its cylindrical region a plurality of windows 6 following one after the other in a circumferential direction. These windows 6 have a somewhat rectangular contour and are enclosed on all four sides by material of the retaining ring.

A clamping element 8 is installed in each of the windows 6, wherein each clamping element lies with its two end sided trunnions 8a against an inner circumferential surface 5a of the retaining ring 5. Only with the right window 6 in FIG. 2 is the clamping element omitted for reasons of clarity. Sheet formed parts 7 with a basket-shaped configuration, which are suspended form-locking in the retaining ring, serve for captive mounting and for biasing of the clamping elements.

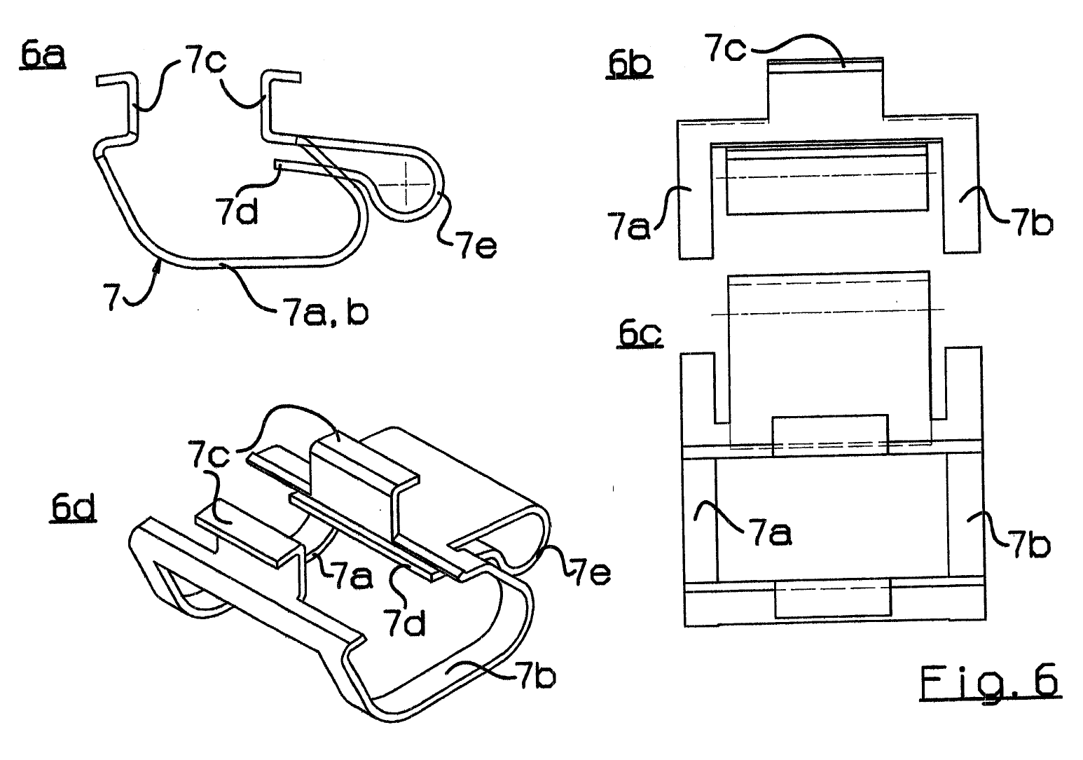

For clarification, reference is made to FIG. 5. One recognizes there in FIG. 5a a side view in the axial direction, in FIG. 5b a view in the circumferential direction, in FIG. 5c a plan view radially from outside, and in FIG. 5d a perspective view. The sheet formed part encloses with its two legs 7a and 7b the clamping element 8 on its two end faces and consequently holds it firmly in an axial direction. Since the two legs run underneath the trunnions 8a of the clamping element 8 on its two end faces and, owing to their profiling and especially owing to their lateral trunnions 8a, the clamping elements cannot slide upward out of the windows 6. They are also held in a radial direction in the retaining ring, and indeed already when these are not yet installed between the outer element (gear wheel) 1 and the inner (shaft) element 4.

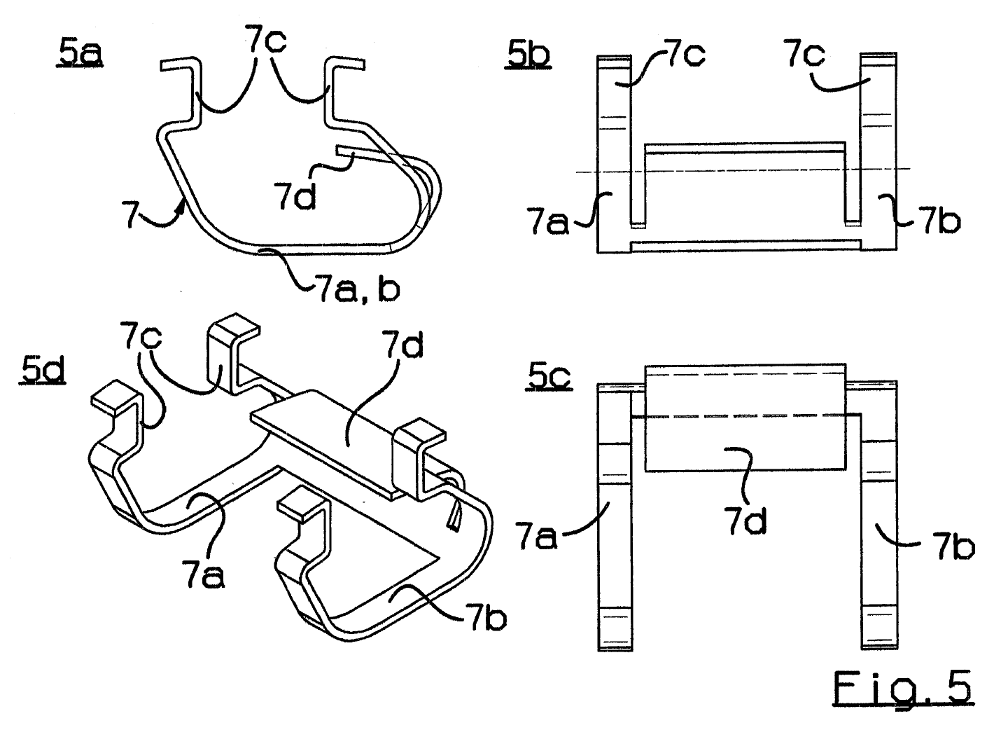

With the type of construction in accordance with FIG. 5, the legs 7a and 7b are bent hook-shaped on their ends, such that the so-formed hooks 7c jut outwardly in opposite directions, so that they can be plugged into the window 6 and hooked there, see FIGS. 2 and 3. The hooks thereby grasp the material of the retaining ring 5 on the radially inner-lying side in a region of the window opening and on the radially outward-lying side, so that they are held by the retaining ring form-locking in the radial direction. But it would also be possible to hook the formed parts not on the windows 6, but on other openings or projections of the retaining ring.

It is now essential that directly in the sheet formed part 7, a bending or flexing spring 7d is formed, and that this flexing spring interacts with the clamping element 8 in such a way that it biases toward an engaging position. In this manner, the previously necessary separate volute buffer springs, the pockets in the retaining ring for accommodating the springs, and above all the sensitive finger tip feeling necessary for inserting the volute buffer springs are omitted.

The assembly of formed parts 7 takes place such that they are first inserted into the windows 6 without the clamping elements. For this purpose, the hook-shaped ends 7c are pressed somewhat together in the circumferential direction, so that they are pushed through the window opening 6 radially from inside toward the outside, and thereafter latch form-locking in the window owing to their internal tension. Then, the clamping element 8 is pressed radially from the inside into the slot between the legs 7a and 7b, wherein these two legs are pressed apart in an axially opposed direction, so that the trunnions 8a of the clamping element pass by the legs. When the clamping elements are sitting properly in the formed part, the legs are released again, so that they spring back, and the clamping elements thereby sit captively, but freely movable for the correct mode of operation in the retaining ring.

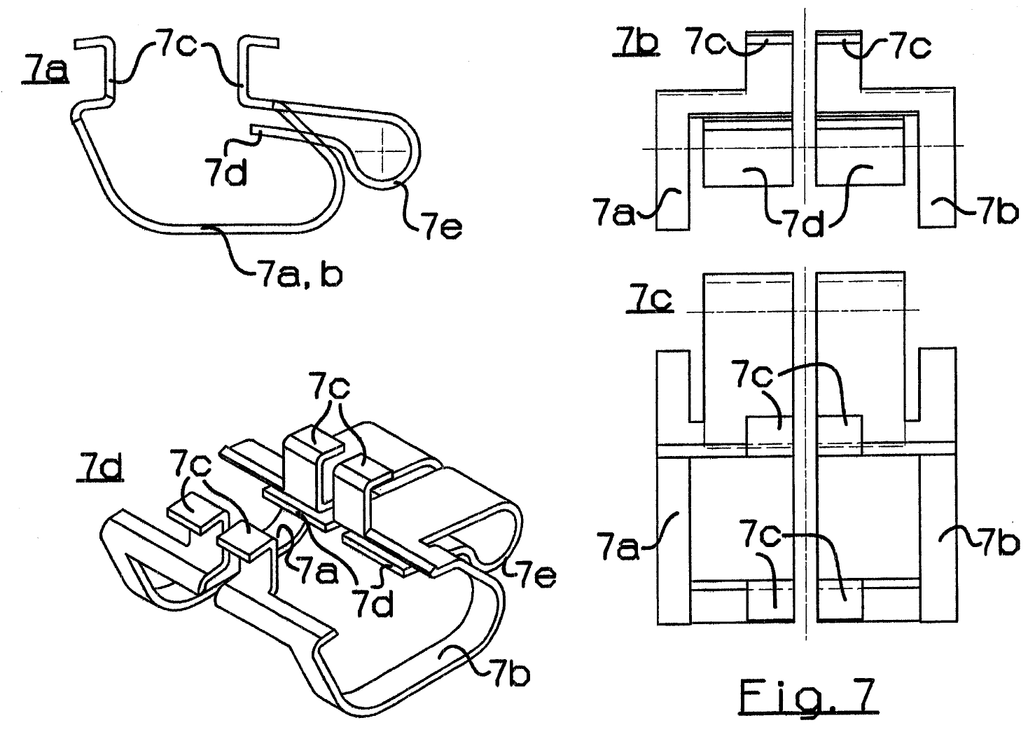

FIG. 4 shows the same view as in FIG. 3, but here the sheet formed part appears somewhat different, namely as is represented in FIG. 6. Here, four hook-shaped projections are thus no longer positioned on the corners of the window 6, but only two projections 7c are arranged centrally on the sheet formed part. Moreover, the spring 7d is constructed somewhat longer and has an additional arch 7e. It is thereby somewhat more elastic.

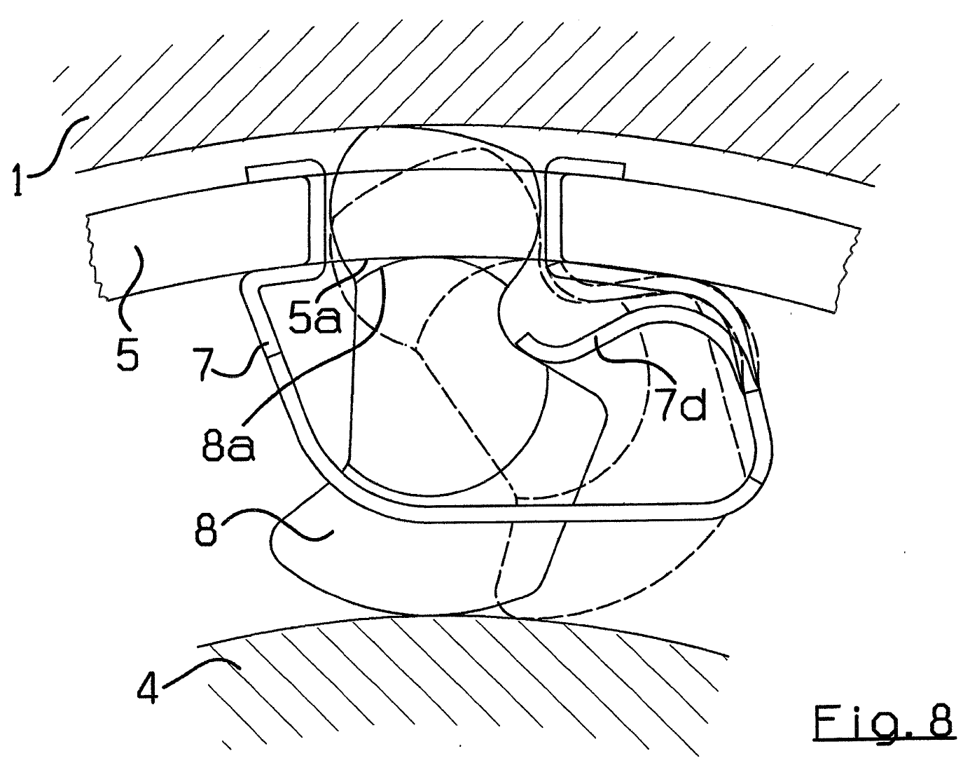

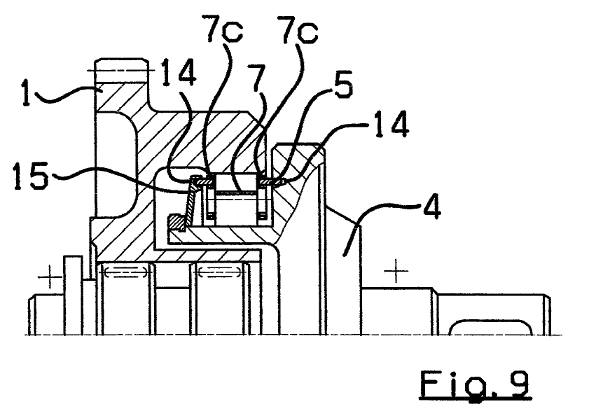

FIG. 7 depicts a third variant for the sheet formed part 7 in the same views as FIG. 5 and 6. Here, it has basically the same shape as in FIG. 6, but is divided by a central separation cut into two mirror image halves.

FIG. 8 shows a clamping element 8 in various positions between the inner and outer track. In the position represented in solid lines, the clamping elements are situated in the engaged (clutched) position, thus in the closed position, while the position represented in dotted lines, in contrast, is in the disengaged (declutched) position. One recognizes clearly in the declutched position that the clamping element is lifted off the outer track on its radially outward-lying clamping surface, owing to the action of centrifugal force. One likewise recognizes that the clamping element here presses back spring 7d, which biases it toward the engaged position.

During the swivelling motion, the clamping elements roll via their two end face trunnions 8a on the radially interior side of the retaining ring 5. The end of the swivelling motion toward a disengaging position is restricted by formed part 7, whose spring 7d develops, with increasing deflection, an ever stronger restoring force and finally functions as a stop.

Finally, in FIG. 9 an additional variant for the retaining ring 5 is illustrated. In this case, the retaining ring has a smooth cylindrical shape without radial bending. Its two axial ends sit in trapezoidal slots 14 of the adjacent parts, in order to bring about the synchronization of the retaining ring with these parts. In this embodiment the adjacent parts are formed first by the shaft-shaped element 4 and second by a plate-shaped element 15 connected with it, wherein the plate-shaped element exerts a pressure in the axial direction against the retaining ring, so that it is pressed over the entire periphery into the grooves 14. For the rest, the same sheet formed parts 7 are suspended in the smooth cylindrical retaining ring, as represented in the previous Figures.

It also lies within the framework of the invention to construct the sheet formed parts 7 without springs 7d and to use separate springs instead.

In sum, the advantage of the present invention consists in that using the one piece retaining ring with windows, the sought after supporting of the clamping elements against centrifugal force is realized with considerably more favorable manufacturing costs than previously, and in that due to the special formed parts 7 with formed-on springs 7d, separate biasing springs for the clamping elements are no longer necessary, so that the construction of the retaining ring as well as its assembly are considerably simplified.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A free wheel retaining ring (5), comprising a plurality of clamping elements (8) pivotably mounted and biased by at least one spring (7d) toward an engaging position, the clamping elements (8) being supported radially outwardly on the retaining ring (5) and executing a swivelling motion toward a disengaging position, under action of centrifugal force against a force of the at least one spring (7d), wherein the retaining ring (5) is formed as one piece and has in its cylindrical region a plurality of windows (6) following one after another in a circumferential direction of the retaining ring, the clamping elements (8) being guided in the circumferential direction while simultaneously being supported radially outwardly by the retaining ring.

2. The retaining ring according to claim 1, wherein the ring runs at a radial level of radially outward-lying halves of the clamping elements (8).

3. The retaining ring according to claim 1, wherein the ring has inner circumferential surfaces (5a) on which end face trunnions (8a) of the clamping elements (8) are supported radially outwardly.

4. The retaining ring according to claim 1, wherein the at least one spring (7d) acting toward the engaging position is separably attached to the retaining ring (5).

5. The retaining ring according to claim 4, wherein the at least one spring (7d) is separably attached by suspension in the windows (6).

6. The retaining ring according to claim 1, wherein the at least one spring (7d) is formed as a one piece formed part (7) together with a clamp captively holding the clamping element (8).

7. The retaining ring according to claim 6, wherein the formed part is a sheet formed part.

8. The retaining ring according to claim 6, wherein the at least one spring (7d) is constructed as a flat bending spring.

9. The retaining ring according to claim 8, wherein the flat bending spring is a leaf spring.

10. The retaining ring according to claim 6, wherein the formed part (7) encloses end face trunnions (8a) of the clamping element (8) for captively holding the clamping element (8) in the retaining ring (5).

11. The retaining ring according to claim 6, wherein the formed part (7) has two lateral legs (7a, 7b) which engage the clamping element (8) on its two end faces.

12. The retaining ring according to claim 11, wherein the two lateral legs (7a, 7b) are suspended in the retaining ring (5).

13. The retaining ring according to claim 11, wherein the two lateral legs (7a, 7b) of the formed part (7) are spreadable elastically in an axial direction in order to permit a radial insertion of the clamping element (8).

14. The retaining ring according to claim 6, wherein the formed part (7) comprises two axially adjacent elements, which are each suspended separately in the retaining ring (5).

15. The retaining ring according to claim 6, wherein several formed parts (7) following one after another in the circumferential direction are combined into a common formed part.

16. The retaining ring according to claim 6, wherein the formed part (7) is formed without the at least one spring (7d).
